(19) United States
(12) Patent Application Publication
(10) Pub. No.: US 2006/0060041 A1
(43) Pub. Date: Mar. 23, 2006

(54) Cutter-sealer and associated method for cutting and sealing polymer sheets

(76) Inventor: Thomas A. Nalle III, Knoxville, TN (US)

Correspondence Address: PITTS AND BRITTIAN P C, P O BOX 51295, KNOXVILLE, TN, 37950-1295, US

(21) Appl. No.: 10/945,771

(22) Filed: Sep. 21, 2004

(51) Int. Cl. B26D 1/00

(52) U.S. Cl. 83/13

(57) ABSTRACT

A cutter-sealer (10) and a method (300) for cutting and sealing target materials (70) together. The cutter-sealer (10) provides a heated blade (20), part of which moves through sheets of tautly held target materials (70) into a slot defined by the seal pad (40). The blade's (20) motion is arrested by a set of blade shoulders (26) that press against the target materials (70) for a period of time, thereby sealing the sheets of target materials (70) together. The method (300) provides a means of cutting target materials (70) without liquefaction and a means of sealing the newly cut edges of the target materials (70) together, also without liquefaction of the target materials (70).

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

The present invention relates to the field of cutting and sealing sheets of polymers.

More particularly, this invention relates to cutting and sealing sheets of polymers and the like, such as the polyethylenes and polyolefins commonly used in products such as bread bags and freezer bags.

2. Description of the Related Art

Cutter-sealers that use heat to form a seal between the edges of sheets of polymer are well known in the art. Typically, a heated blade is brought to bear on two sheets of a polymer supported by a rubber seal pad covered with Teflon tape underneath the point of contact. The heated blade melts the polymer and divides it in two by using the force of the heated blade pressing against the solidly supported polymer to push liquefied polymer to each side of the blade. The liquefied polymer pushed to each side of the blade seals the edges of the newly divided polymer together. Thus the typical polymer cutter-sealer uses heat to both divide and seal in a single operation.

The use of heat to both cut and seal is possible because of the unique properties of polymers, which are simply substances whose molecules have high molar masses and are composed of a large number of repeating units. Polymers are generally formed by chemical reactions in which a large number of molecules called monomers are joined sequentially, forming a chain. Plastic is the most common example of a polymer. A polymer's reaction to heat is determined by the molecules used as monomers and the structure of the chain. Polyethylenes, for example, are a subset of polymers in which the chains are formed by a double bond between carbon atoms. Polyethylenes are commonly used for containers such as bread bags and freezer bags, which are often made from sheets of materials that are cut to the desired length and sealed together to form the closed end of the container in an operation similar to that described above.

Obviously, the speed and quality with which containers can be produced is a significant factor in a competitive marketplace. Hence, several machines and techniques have been developed that focus on this particular aspect of the manufacturing process. Many of these use heat to both divide and seal, but the use of heat simultaneously for both operations forces conventional cutter-sealer blades to be heated to temperatures well above the melting point of the target materials so that the necessary liquefaction occurs. The liquefaction of polymers, however, creates residue on the blade, which can stop production for removal of the residue or cause incomplete cuts and faulty seals if left unchecked. Further, the high temperatures that are necessary make it difficult for human operators to interact with the process. Furthermore, the blade design dictated by the use of liquefied polymer produces a thin seal because only the material pushed to the sides of the blade creates the seal, and there is the possibility that a conventional blade may not push equal amounts of material to both sides, creating a thinner seal than normal on one side and more residue that normal on the other.

### BRIEF SUMMARY OF THE INVENTION

The present invention provides a cutter-sealer which can operate at lower temperatures than conventional cutter-sealers, and a method for cutting sheets of polymers, such as polyethylene sheets, and sealing the newly cut edges together to form the closed end of a wide variety of containers such as bread bags and freezer bags. The apparatus includes a heated blade, a seal pad, and a seal pad caddy.

The heated blade of the cutter-sealer has a somewhat narrow, elongated cutting section that includes a distal end defining a cutting edge. The cutting section terminates on a second side opposite the cutting edge in a set of blade shoulders that flare outward from the cutting section. A seal pad, which is made of rubber or a similar material, provides a slot designed to receive the cutting section of the blade at the end of its cutting motion. The seal pad also provides a set of flexible seal pad shoulders for the blade shoulders to push against during the sealing operation. A seal pad caddy is provided to hold the seal pad securely in place.

The cutter-sealer blade divides the target materials by moving the cutting section through the target materials as they are held tautly over the slot in the seal pad, with a combination of heat and blade pressure causing the cutting of the materials. Because the blade is not solely dependent on heat to divide the target materials like conventional blades, the amount of heat needed to divide the target materials is substantially reduced. Subsequent to the cutting section of the blade moving through the target materials, the blade shoulders arrest the motion of the cutting section as it moves into the slot in the seal pad, pinning the edges of the newly cut target materials against the sides and the flexible seal pad shoulders adjacent the slot. The blade continues to apply force in the direction used to divide the target material. The applied force causes the blade shoulders to press the newly cut edges together and against the seal pad shoulders where the flexibility of the seal pad shoulders smoothes out any irregularities in the surface of the target materials. Heat is then transmitted from the blade shoulders to the sheets of target materials thus creating a laminate seal that bonds the sheets of target materials together.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a partial perspective view of one embodiment of a cutter-sealer of the present invention.

FIG. 2 is a side elevation view of one embodiment of a cutter-sealer in accordance with the present invention in operation.

FIG. 3 is a side elevation view of a prior art cutter-sealer in operation.

FIG. 4 is side elevation view of one embodiment of a cutter-sealer of the present invention.

FIG. 5 is a flow diagram of one method of sealing and cutting in accordance with the present invention.

### DETAILED DESCRIPTION OF THE INVENTION

A cutter-sealer and a method for cutting and sealing sheets of one or more target materials are hereinafter disclosed. The target materials include, but are not limited to, polymers and more specifically, polyethylenes such as those used in making everyday items like bread bags and freezer bags. The cutter-sealer is illustrated generally at 10 in the figures, and, as will be discussed below, is designed to operate at lower temperatures than prior art cutter-sealers.

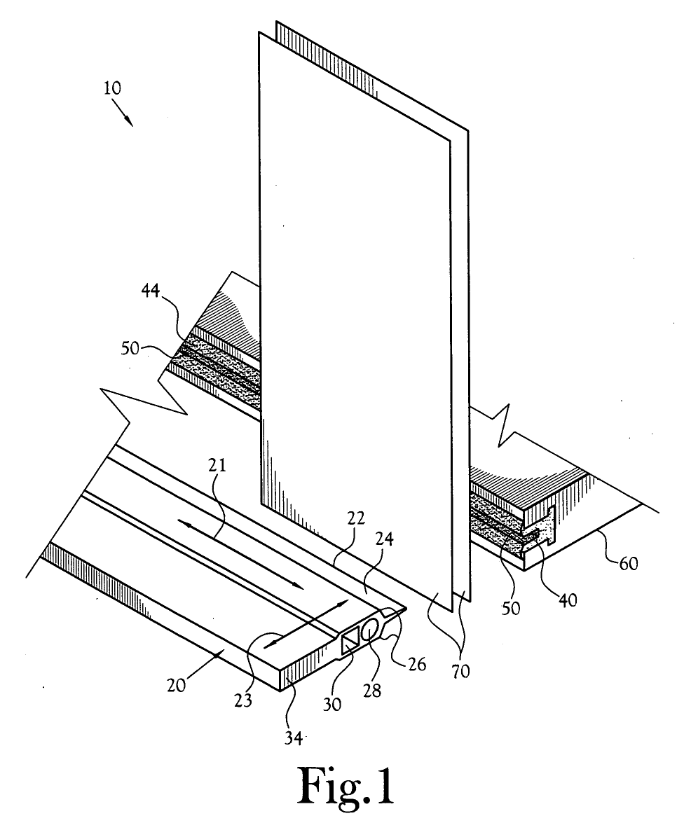

As illustrated in FIG. 1, the cutter-sealer 10 includes a blade 20 that is selectively heated, a seal pad 40, and a seal pad caddy 60, that cooperate to allow sheets of one or more target materials 70 to be cut and sealed in separate, but temporally proximate operations at temperatures below the melting point of the target materials 70. The blade 20 is designed for mounting on an arm or a machine that moves the blade in the direction of a cutting motion arrow 23 with the force necessary for the cutting and sealing operations. The blade 20 has a shank 34 that provides a stable area for mounting the blade on a mechanism that selectively reciprocates the blade 20. It will be understood that the shank 34 may vary in size and configuration depending upon the reciprocating mechanism in which it is mounted. The blade 20 is made of one or more substances that are rigid and have a relatively high degree of thermal conductivity such as aluminum, although different substances may be used. It will also be noted that in one embodiment the blade is coated with a non-stick treatment to prevent the target materials from sticking to the blade. Further, it will be understood that the longitudinal dimension 21 of the blade 20 can vary, and is generally determined by the size of the sheets of target materials to be cut and sealed.

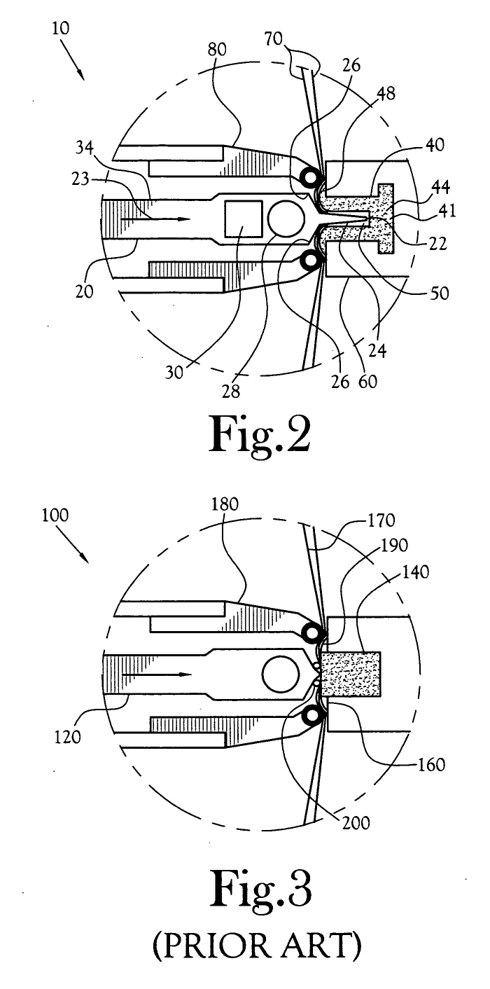

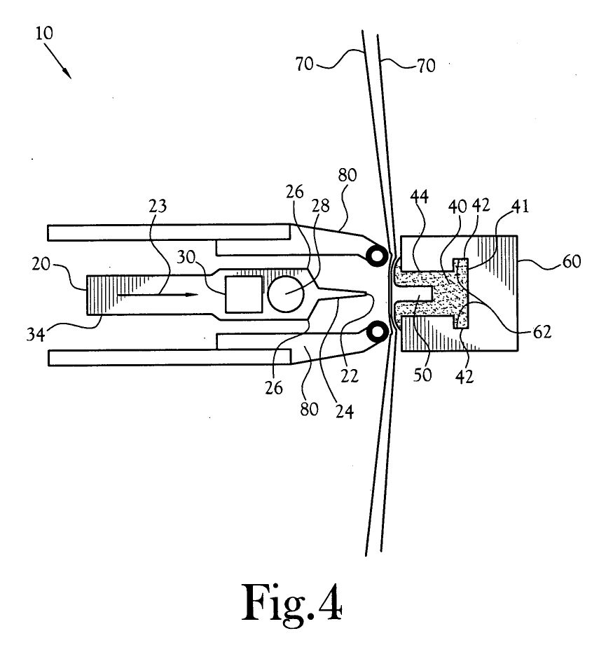

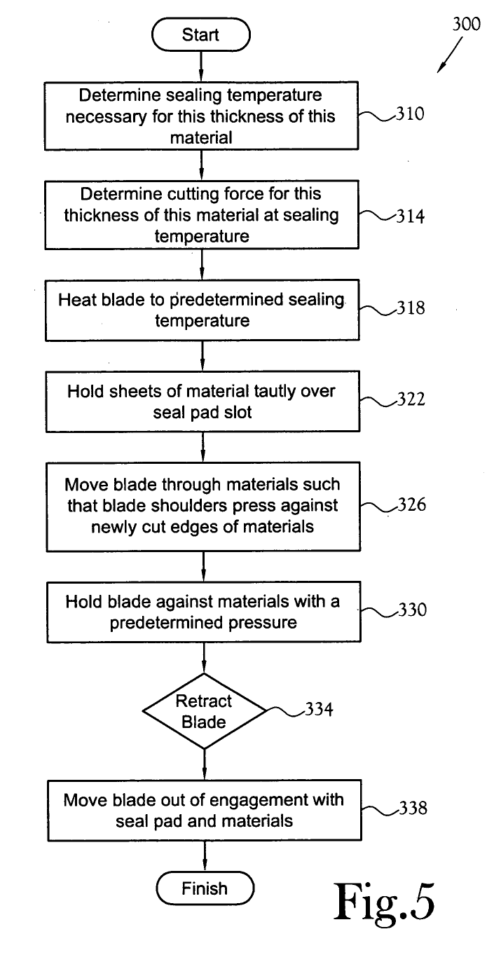

FIG. 2 shows the cutter-sealer 10 in operation. As illustrated the blade 20 defines a cutting section 24 terminating in a cutting edge 22. The cutting edge, in one embodiment, has a relatively small radius of curvature so that the blade 20 can easily divide the target material. However, it will be understood that the radius of curvature and the temperature of the cutting edge 22 may vary while still remaining within the scope of the current invention. Moreover, the cutting edge 22 may define a sharp edge if desired. As will be discussed in detail below, the cutting section 24 is adapted to cut by moving through a section of target materials held tautly across an opening (see FIG. 4) adapted to receive the cutting section 24. Further, the blade 20 defines oppositely disposed shoulders 26 that, as discuss below, serve to engage and assist in the sealing of the cut edges of the target material once the cutting section 24 has moved through the target material. It will be understood that the size, shape, and operating temperature of the shoulders 26 can vary substantially without exceeding the scope of the current invention.

In order to heat the blade 20 to the desired temperature for cutting and sealing, in one embodiment, the blade 20 is provided with a heater receptacle 28 that is adapted to receive a heater element (not shown) for transferring heat to the shoulders 26 in order to seal the target materials together. The heater receptacle 28 in the embodiment of FIG. 2 is a through opening centered between the shoulders 26 of the illustrated blade 20. However, it will be recognized by those skilled in the art that heat may be provided to the blade 20 in different ways. Heat may be provided without the insertion of a heating element at all, or heat may be provided by the insertion of multiple heater elements. The need for a heater receptacle 28 is thus eliminated in the former situation and more than one heater receptacle 28 must be accommodated in the latter situation. Furthermore, any or all of the heater receptacles 28 in the blade 20 may vary in size, shape, position, or material. It will also be noted that, the blade 20 can be provided with a cooling channel 30 adapted to reduce the thermal conductivity of the blade 20 from the cooling channel 30 in the direction of the shank 34. Accordingly, when the shoulders 26 and cutting section 24 of the blade 20 are heated to the desired operating temperature, the shank 34, where heating is not necessary, is maintained at lower temperature.

As shown in FIGS. 1, 2 and 4, the seal pad 40 defines an elongated body 44 defining a seal pad slot 50 for receiving at least a portion of the cutting section 24 of the blade 20. Further, the seal pad 40 defines seal pad shoulders 48 disposed on opposite sides of the slot 50. As will be discussed in detail below, the shoulders 48 provide a sealing surface against which the shoulders 26 of the blade 20 press to accomplish the sealing of the target materials once such materials have been cut. In this regard, in one preferred embodiment the seal pad 40, at least the shoulders 48 thereof are made of a flexible material, such as rubber, the contours of which conform to the shape of shoulders 26 of the blade 20 when the shoulders 26 are pressed against the seal pad 40 in order to ensure an even seal despite any irregularities in the target materials 70 that might exist. Moreover, the flexibility compensates for any small irregularities in the blade surface and seal pad 40.

The seal pad 40 is mounted in the seal pad caddy 60 which provides a mechanism for releasably locking the seal pad 40 into the seal pad caddy 60. The combination of seal pad 40 and seal pad caddy 60 thus creates a structure with the seal pad slot 50, capped by the set of seal pad shoulders 48, on one side but bounded on the remaining five sides by what is essentially a case made of a strong, rigid material such as aluminum. In this regard, the use of aluminum facilitates the dissipation of heat, but it will be understood that other fabricating materials could be used. The rigidity and strength of the seal pad caddy 60 allows the seal pad 40 to be held stationary without damage. With respect to the mechanism for releasably locking the seal pad 40 in the seal pad caddy 60, as illustrated in FIG. 4, in one embodiment the caddy 60 defines an elongated groove 41 into which the seal pad 40 is received, with the groove 41 defining opposing slots 62. Further, the seal pad is provided with oppositely disposed feet 42 for being slidably received in the slots 62, and which hold the seal pad 40 in the groove 41. It will, however, be understood that other means could be used to secure the seal pad 40 to the seal pad caddy 60.

The operation of the cutter-sealer 10 also contemplates that the target materials be held tautly over the seal pad slot 50 such that the target materials are not carried into the slot 50 as the blade moves into the slot 50 rather than be cut by the blade 20. As illustrated in FIGS. 2 and 4, in one embodiment this is accomplished by a set of seal jaws 80 that press the sheets of target materials 70 on either side of the seal pad slot 50 against surfaces provided by the seal pad caddy 60. However, other means of holding the target materials tautly over the seal pad slot 50 may be used without departing from the scope and spirit of the current invention or altering the result.

With respect to the method for cutting and sealing, sheets of the target materials 70, positioned in adjacent or substantially adjacent parallel planes, are placed between the heated blade 20 and the seal pad 40 as illustrated in FIG. 4. The seal jaws 80 press the target materials 70 against the seal pad caddy 60, thereby creating the required taut section of target materials 70 over the seal pad slot 50. The target materials 70 are cut by the movement of the heated blade 20 through the target materials 70 and partially into the seal pad slot 50, where the blade's 20 motion is arrested by the blade shoulders 26. Because the blade 20 relies on both heat and pressure to divide the target materials 70, rather than heat alone, the cutting second of the blade 20 can be maintained at a lower temperature for the cutting and sealing of many target materials 70. As illustrated in FIG. 2, the blade shoulders 26 press the newly cut target materials 70 against the seal pad shoulders 48 and transfer heat to the newly cut edges of the target materials 70 to seal them together. In this regard, by applying both heat and pressure to the edges of the target materials, rather than merely applying heat, the seal is accomplished without totally liquefying the edges of the target materials as with conventional cutter-sealers, thereby allowing the blade 20 to be maintained at lower temperatures for most target materials. Of course, the desired or optimum temperature of the blade 20, and the desired or optimum length of time during which pressure is applied to the target materials by the blade shoulders 26, will vary depending upon the particular target materials being cut and sealed.

In this regard, the characteristics of the present invention may be more clearly understood when viewed in light of prior art. FIG. 3, for example, shows a prior art cutter-sealer 100 in operation. In the figure, sheets of one or more target materials 170, positioned in adjacent or nearly adjacent parallel planes, are placed between a heated blade 120 and a seal pad 140 which is not provided with a seal pad slot. A set of seal jaws 180 presses the target materials 170 against a seal pad caddy 160, thereby holding the target materials 170 in place. The heated blade 120 melts through the target materials 170, pushing molten target material 170 to each side as it presses against the seal pad 120. The seal in the prior art cutter-sealer 100 is actually formed by the molten target material 170 pushed aside by the blade 120. The molten target material 170 forms a small bead 200 that tends to cause residue to be left on the heated blade 120. The prior art cutter-sealer is also shown with a strip of Teflon tape 190 on top of the seal pad 120 and underneath the target materials 170 to prevent residue from clinging to the seal pad 140. By not relying on the cutting edge of the blade to accomplish the sealing of the target materials, the cutter-sealer 10 reduces the buildup of molten target materials on the cutting section 24 of the blade 20 and allows the cutting section 24 of the blade to be maintained at a lower temperature.

FIG. 5 provides a flow diagram illustrating one method 300 for cutting and sealing sheets of target materials 70 in accordance with the present invention. The first steps are to determine the temperature to which the blade 20 must be raised to seal the target materials 70 (referenced at 310) and to determine the cutting force which the blade 20 must exert against the target materials 70 to cut them (referenced at 314). For example, for 1 mil polyethylene, the blade 20 temperature is preferably between 190 and 220 degrees. (A conventional method and device would require a temperatures between 325-360 degrees). The blade 20 is then brought up to the previously determined temperature as referenced at 318. The sheets of target materials 70 are then held tautly across the seal pad slot 50 until the blade 20 cuts and seals the target material, and the blade is retracted as referenced at 322 in FIG. 5. The blade 20 is then moved with the predetermined cutting force through the target materials 70 so that the shoulders 26 of the blade are engaged with the newly cut edges of the target materials 70 as referenced at 326. The blade 20 is then held in that position, with a predetermined pressure applied 330 until conditions indicate 334 that it is time to retract the blade 20 as referenced at 330. Finally, the blade 20 is retracted from engagement with the seal pad 40 and the target materials 70 as referenced at 334 and 338.

From the foregoing description, it will be recognized by those skilled in the art that an cutter-sealer 10 and a method 300 for cutting and sealing target materials 70 together has been provided. The cutter-sealer 10 and method 300 provide a means of cutting target materials 70 at lower temperatures than is possible with prior art devices. As a result there is less buildup of target material on the blade 20, and the overall cutting and sealing operation is safer.

While the present invention has been illustrated by description of several embodiments and while the illustrated embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A cutter-sealer for cutting and sealing sheets of target material, said cutter-sealer comprising:
a blade for being selectively heated and for cutting and sealing sheets of the target material, said blade having a cutting section with a distal portion defining a cutting edge, said blade defining at least a first blade shoulder rearward of said cutting section, said first blade shoulders being adapted for engaging the target materials and for transferring heat to the target materials in order to seal sheets of the target materials together;
a seal pad defining a seal pad slot adapted for receiving at least a portion of said cutting section of said blade, whereby at least a portion of said cutting section of said blade travels into said seal pad slot after said cutting edge moves through said target materials, said seal pad being provided with at least a first sealing surface proximate said seal pad slot against which the target material is press by said first blade shoulder to accomplish the sealing of the target material; and
a seal pad caddy for holding said seal pad in place.

2. The cutter-sealer of claim 1 wherein said blade defines a second blade shoulder oppositely disposed to said first blade shoulder and wherein said seal pad is provided with a second sealing surface proximate said seal pad slot against which the target material is press by said second blade shoulder to accomplish the sealing of the target material.

3. The cutter-sealer of claim 2 wherein said blade defines a heater receptacle adapted for receiving a heating element.

4. The cutter-sealer of claim 3 wherein said seal pad is fabricated of a flexible material.

5. The cutter-sealer of claim 4 wherein said seal pad caddy defines at least a first material fixation surface, and wherein said cutter-sealer is provided with means for securing the target material against said first material fixation surface, whereby the sheets of target material are held in place by pressing the sheets of target material against said first material fixation surface.

6. The cutter-sealer of claim 2 wherein said at least said cutting section of said blade is coated with a non-stick coating.

7. The cutter-sealer of claim 2 wherein said cutter-sealer is provided with means for holding the target materials in position over said seal pad slot to facilitate the cutting of the target material.

8. The cutter-sealer of claim 7 wherein said seal pad caddy defines at least a first material fixation surface, and wherein said cutter-sealer is provided with means for securing the target material against said seal pad caddy, whereby the sheets of target material are held in place by pressing the sheets of target material against said first material fixation surface.

9. The cutter-sealer of claim 8 wherein said seal pad defines a second material fixation surface disposed on the opposite side of said seal pad slot from said first material fixation surface, and wherein said means for securing the target material against said seal pad caddy selectively presses the target material against said first and second material fixation surfaces.

10. The cutter-sealer of claim 9 wherein said seal pad is fabricated of a flexible material.

11. A method for cutting and sealing sheets of target materials, said method utilizing a blade capable of being heated, the blade defining a cutting section having a cutting edge and a pair of oppositely disposed blade shoulders rearward of the cutting section, and utilizing a seal pad defining a seal pad slot for receiving at least a portion of the cutting section of the blade, said method comprising the steps of:
(a) Heating a blade to a predetermined temperature;
(b) Holding sheets of target materials tautly across the seal pad slot;
(c) Moving the cutting section of the blade through the target materials with a predetermined cutting force until the blade shoulders arrests the movement of the blade into the seal pad slot and engage the edges of the newly cut target materials;
(d) Pressing the heated blade shoulders against the edges of the newly cut target materials with a predetermined sealing pressure in order to form a laminate seal; and
(e) Retracting the blade out of engagement with the target materials.

12. The method of claim 11, and before said step of heating a blade to a predetermined temperature, wherein said method further comprises the step of determining a cutting temperature and a sealing temperature of the blade.

13. The method of claim 12, and before said step of moving the blade through the target materials with a predetermined cutting force, wherein said method further comprises the step of determining a cutting force based on the cutting temperature.

14. The method of claim 13, and before said step of pressing the blade shoulders against the edges of the newly cut target materials with a predetermined sealing pressure in order to form a laminate seal, wherein said method further comprising the step of determining a sealing pressure.

15. The method of claim 14, and before said step of retracting the blade out of engagement with the target materials, wherein said method further comprises the step of determining when to retract said blade out of engagement with the target materials.

16. The method of claim 15 where the target materials are polyethylenes.
